(19) United States
(12) Patent Application Publication
(10) Pub. No.: US 2017/0285722 A1
(43) Pub. Date: Oct. 5, 2017

(54) METHOD FOR REDUCING BATTERY CONSUMPTION IN ELECTRONIC DEVICE

(71) Applicant: Samsung Electronics Co., Ltd., Gyeonggi-do (KR)

(72) Inventor: Soo-Hyung KIM, Gyeonggi-do (KR)

(21) Appl. No.: 15/507,140

(22) PCT Filed: Aug. 27, 2014
(86) PCT No.: PCT/KR2014/007985

§ 371 Date: Feb. 27, 2017

(51) Int. Cl. G06F 1/32

(52) U.S. Cl. CPC G06F 1/329; G06F 1/3212; G06F 1/3296

(57) ABSTRACT

The present disclosure relates to an apparatus and method for reducing battery consumption in a low-power mode in an electronic device, and the electronic device includes: a measurement module configured to measure an amount of consumption current of a battery in a low-power mode; a determination module configured to determine a time to clean at least one process; and a cleaning module configured to, when it is determined that it is necessary to clean at least one process, terminate at least one process which is being operated in the low-power mode.

### TECHNICAL FIELD

The present disclosure relates to an apparatus and method for reducing battery consumption in a low-power mode in an electronic device.

### BACKGROUND ART

As electronic devices have been rapidly developing in recent years, electronic devices which are able to perform wireless voice communication and exchange information have become necessities in our daily life. At the early stage of distribution of electronic devices, the electronic devices were recognized as being capable of being simply carried and of performing wireless communication. However, as relevant technology has developed and wireless Internet has been introduced, the electronic devices have a wide range of applications, such as a game, a remote controller using short-distance communication, or photographing an image using a digital camera mounted therein, in addition to their normal functions such as making a call or managing schedules, and thus are meeting users' diverse demands.

The above-described electronic device provides multimedia services and thus an amount of information to be processed or an amount of information to be displayed increases. Accordingly, there is increasing interest in an electronic device provided with a touch screen which is able to increase the size of a display by making better use of a space.

The touch screen is an input or display device through which information is inputted and displayed on a single screen. Accordingly, if the touch screen is used, the electronic device may not require a separate input device such as a keypad and thus can increase a display area. For example, if a full touch method in which the touch screen is applied to a full screen is used, the front surface of the electronic device can be utilized as a screen and the size of the screen can be increased.

Such an electronic device uses a battery as a power supplying means and requires a battery of a larger capacity due to the development of the electronic device.

However, the development of the battery is not comparable to the development of the electronic device, and the capacity of the battery may be limited.

The electronic device may enter a low-power mode to reduce consumption of the battery. The low-power mode may be an operation of applying low power to a module which may consume power by a threshold value or more in the electronic device. For example, if the electronic device does not detect a user's input during a predetermined time, the electronic device may process to apply low power to a backlight unit, a short-distance communication module, etc.

### DETAILED DESCRIPTION OF THE INVENTION

### Technical Problem

Various exemplary embodiments of the present disclosure provide an apparatus and method for reducing battery consumption in an electronic device.

Various exemplary embodiments of the present disclosure provide an apparatus and method for reducing battery consumption by stopping an operation of at least one process which consumes a battery based on an amount of battery consumption current in an electronic device which enters a low-power mode.

Various exemplary embodiments of the present disclosure provide an apparatus and method for measuring an amount of battery consumption current in a low-power mode based on a state of charge of the battery, a voltage of the battery, an amount of electric charge inputted to or outputted from the battery, etc. in an electronic device.

Various exemplary embodiments of the present disclosure provide an apparatus and method for defining a group of a process for stopping an operation according to an amount of battery consumption current in an electronic device.

### Solution to Problem

According to an exemplary embodiment of the present disclosure, an electronic device includes: a measurement module configured to measure an amount of consumption current of a battery in a low-power mode; a determination module configured to determine a time to clean at least one process; and a cleaning module configured to, when it is determined that it is necessary to clean at least one process, terminate at least one process which is being operated in the low-power mode.

The measurement module may measure the amount of consumption current of the battery based on at least one of a State Of Charge (SOC) of the battery, a voltage of the battery, and an amount of electric charge inputted to or outputted from the battery.

The measurement module may measure the amount of consumption current of the battery based on a predetermined time period, or measure the amount of consumption current of the battery based on a change in a measurement value of at least one of an SOC of the battery, a voltage of the battery, and an amount of electric charge inputted to or outputted from the battery.

The cleaning module may automatically terminate a process which is being operated at the time of cleaning the at least one process, or may terminate a process which is being operated according to user's selection.

The cleaning module may terminate a process which is being operated according to a level corresponding to at least one of the measured battery consumption current, a SOC of the battery, and a voltage of the battery.

The cleaning module may additionally terminate an operation of at least one process which is being operated after terminating the process which is being operated according to the level.

The cleaning module may terminate an operation of at least one process which occupies a memory or a processor.

The electronic device may further include an output module to output an operation of cleaning the at least one process.

The output module may output at least one operation of an operation of selecting a process to be cleaned at the process cleaning time, an operation of informing of the time of the process cleaning operation, an operation of informing of execution of the process cleaning operation, and an operation of informing a result of cleaning a process.

According to an exemplary embodiment of the present disclosure, a method of an electronic device includes: determining whether a battery is consumed by a predetermined threshold value or more based on an amount of consumption current of the battery in a low-power mode; and, when the battery is consumed by the predetermined threshold value or more, terminating at least one process which is being currently operated.

The amount of consumption current of the battery may be periodically measured at predetermined times, or may be measured based on a change in a measurement value of at least one of an SOC of the battery, a voltage of the battery, and an amount of electric charge inputted to or outputted from the battery.

The terminating the at least one process may be performed in a state in which the low-power mode is maintained or a state in which the low-power mode is disabled.

The terminating the at least one process may include terminating a process which is being operated based on the consumption current of the battery.

The terminating the at least one process may include: terminating at least one process which consumes the battery; and additionally terminating an operation of at least one process from among processes which are being operated.

The terminating the at least one process may include terminating at least one process which is being currently operated using an application for controlling an operation of a process.

The method may further include: determining whether the at least one process which is being currently operated satisfies a predefined condition or not; and ruling at least one process satisfying the condition out of the processes to be terminated, and wherein the predefined condition may include at least one of preference for the process, frequency of use, and priority.

The method may further include outputting the operation of terminating the at least one process to at least one display device functionally connected with the electronic device or at least one other electronic device communicably connected with the electronic device.

The at least one other electronic device communicably connected with the electronic device may include a wearable electronic device.

The outputting to the display device or the other electronic device may include at least one of: selecting a process to be cleaned at the process cleaning time; informing of the time of the process cleaning operation, informing of execution of the process cleaning operation, and informing of a result of cleaning a process.

According to an exemplary embodiment of the present disclosure, a computer readable recording medium records a program for executing: a process of measuring an amount of consumption current of a battery in a low-power mode and determining a time at which the battery is consumed by a threshold value or more, and a process of terminating a process which consumes the battery when the battery is consumed by the threshold value or more.

### Advantageous Effects of Invention

As described above, the electronic device which enters the low-power mode measure the amount of consumption current of the battery and terminates the operation of at least one process which consumes the battery, so that time of use of the battery and waiting time can be enhanced.

### BRIEF DESCRIPTION OF DRAWINGS

FIG. 1 is a block diagram showing a configuration of an electronic device for reducing battery consumption in a low-power mode according to an exemplary embodiment of the present disclosure;

FIG. 2 is a view showing a detailed block configuration of a processor for reducing battery consumption in a low-power mode according to an exemplary embodiment of the present disclosure;

FIG. 3 is a flowchart showing an operation of reducing battery consumption in an electronic device according to an exemplary embodiment of the present disclosure;

FIG. 4 is a flowchart showing an operation of reducing battery consumption in an electronic device according to an exemplary embodiment of the present disclosure;

FIG. 5 is a view showing a situation in which an amount of consumption current of a battery is periodically measured at predetermined times in an electronic device according to an exemplary embodiment of the present disclosure;

FIG. 6 is a view showing a situation in which an amount of consumption current of a battery is periodically measured at predetermined times in an electronic device according to an exemplary embodiment of the present disclosure;

FIG. 7 is a view showing an operation of an electronic device for reducing power consumption in a low-power mode according to an exemplary embodiment of the present disclosure;

FIG. 8 is a view showing another operation of the electronic device for reducing power consumption in the low-power mode according to an exemplary embodiment of the present disclosure; and

FIG. 9 is a view showing another operation of the electronic device for reducing power consumption in the low-power mode according to an exemplary embodiment of the present disclosure.

### BEST MODE FOR CARRYING OUT THE INVENTION

Hereinafter, the operation principles of the present disclosure will be explained in detail with reference to the accompanying drawings. In the following description, well-known functions or constructions are not described in detail since they would obscure the invention in unnecessary detail. Also, the terms used herein are defined according to the functions of the present invention. Thus, the terms may vary depending on user's or operator's intension and usage. That is, the terms used herein must be understood based on the descriptions made herein.

In the following description, a method and apparatus for reducing battery consumption in an electronic device according to various exemplary embodiments of the present disclosure will be explained.

In general, the electronic device may enter a low-power mode and thus can reduce battery consumption. The low-power mode is a mode in which, when a user's input is not detected during a predetermined time, low power is applied. For example, the electronic device may enter the low power mode while stopping the operation of a display.

The electronic device may determine that a user does not use the electronic device, and enter the low power mode and thus can reduce battery consumption.

Even when the electronic device enters the low-power mode as described above, the battery may be consumed in the electronic device. For example, the current may be consumed because some functions or applications, etc. of the electronic device occupy a memory or a processer even when the electronic device enters the low-power mode.

The electronic device may determine a situation in which current is abnormally consumed, for example, a situation in which an amount of consumption current greater than or equal to a threshold value is measured in the low-power mode, by measuring the amount of battery consumption current in the low-power mode. When it is determined that the current is abnormally consumed, the electronic device may process to stop an operation of at least one process or application. According to an exemplary embodiment, the electronic device may terminate the operation of the at least one process or application. According to another exemplary embodiment, the electronic device may terminate the operation of the at least one process or application during a predefined time. According to an exemplary embodiment, the predefined time may be a time at which the battery starts being charged. For example, when an amount of consumption current greater than or equal to a threshold value is measured in the low-power mode, the electronic device may temporarily terminate the operation of the at least one process or application and then may restart the terminated operation of the process or application at the time when the battery is charged.

The electronic device may identify the amount of battery consumption current using a change in the State Of Charge (SOC) of the battery during a predetermined time.

Since the electronic device may measure the SOC of the battery based on a voltage of the battery, the electronic device may identify the amount of battery consumption current using a change in the battery voltage during a predetermined time.

Since the electronic device may measure the amount of battery consumption current using an amount of electric charge inputted to or outputted from the battery, the electronic device may identify the amount of battery consumption current during a predetermined time using the amount of electric charge of the battery.

This is not limited to the data which is necessary for measuring the consumption current of the battery in the electronic device, and the operation of the at least one process or application which consumes the battery may be stopped using various data.

When the electronic device determines that the current is abnormally consumed in the low-power mode, the electronic device may automatically stop the operation of the process or application which consumes the battery, or stop the operation of the process or application which consumes the battery according to user's selection.

An electronic device according to the present disclosure may be a device including a communication function. For example, an electronic device may include at least one of a smartphone, a tablet personal computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, an electronic bracelet, an electronic necklace, an electronic appcessory, a camera, a wearable device, an electronic clock, a wrist watch, a smart white appliance (e.g., a refrigerator, an air conditioner, a cleaner, an artificial intelligent robot, a TeleVision (TV), a Digital Video Disk (DVD) player, an audio, an oven, a microwave oven, a washing machine, an air purifier, an electronic picture frame, etc.), various medical devices (e.g., Magnetic Resonance Angiography (MRA), Magnetic Resonance Imaging (MRI), Computed Tomography (CT), imaging equipment, ultrasonic instrument, etc.), a navigation device, a Global Positioning System (GPS) receiver, an Event Data Recorder (EDR), a Flight Data Recorder (FDR), a set-top box, a TV box (e.g., Samsung HomeSync™, Apple TV™, or Google TV™), an electronic dictionary, a car infotainment device, an electronic equipment for ship (e.g., a vessel navigation device, a gyro compass, etc.), avionics, a security device, an electronic costume, an electronic key, a camcorder, game consoles, a Head-Mounted Display (HMD), a flat panel display device, an electronic album, a furniture or a part of building/constructions including a communication function, an electronic board, an electronic signature receiving device, a projector, etc.

It is apparent to those ordinarily skilled in the art that the electronic device according to various embodiments of the present disclosure is not limited to the aforementioned devices.

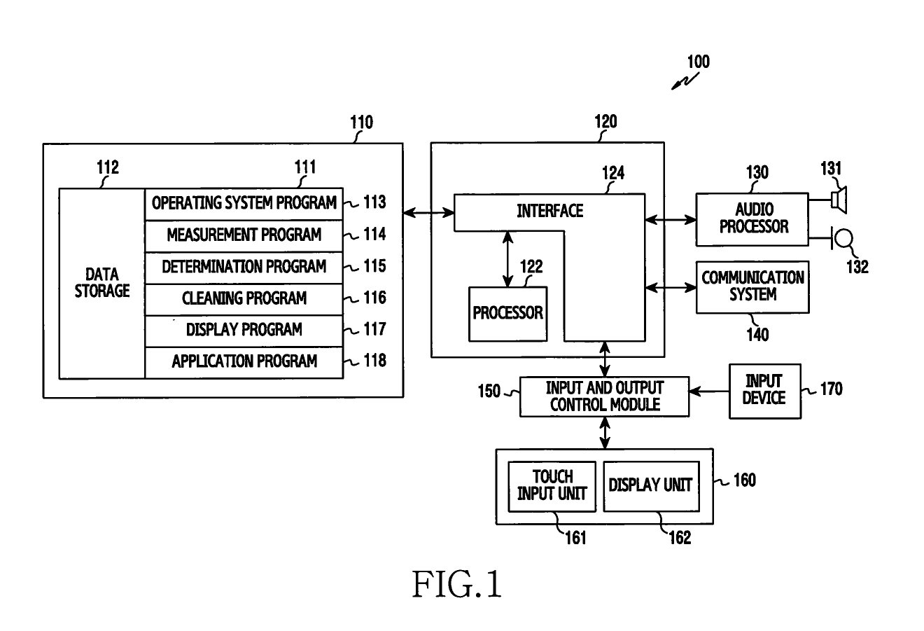

FIG. 1 is a block diagram showing a configuration of an electronic device for reducing battery consumption in a low-power mode according to an exemplary embodiment of the present disclosure.

As shown in FIG. 1, the electronic device 100 may include a memory 110, a processor unit 120, an audio processor 130, a communication system 140, an input and output controller 150, a touch screen 160, or an input device 170. At least one of the above-described elements may be provided in plural number.

Each of the elements will be explained.

The memory 110 may include a program storage 111 to store a program for controlling the operation of the electronic device 100, or a data storage 112 to store data which is generated while a program is being executed. For example, the data storage 112 may store various data for storing, which are updatable, such as a phone book, a sent message, or a received message, and may store information of a process which should be cleaned according to a level of an amount of battery consumption current.

The data storage 112 may store data which is necessary for measuring an amount of consumption current of a battery.

The program storage 111 may include an operating system program 113, a measurement program 114, a determination program 115, a cleaning program 116, an output program 117, or at least one application program 118. Herein, a program included in the program storage 111 is a set of instructions and may be expressed as an instruction set.

The operating system program 113 may include various software elements for controlling a normal system operation. Controlling the normal system operation may refer to managing or controlling a memory, controlling or managing storage hardware (device), or controlling or managing power. The operating system module 113 may perform a function of facilitating communication between a variety of hardware (devices) and a program element (module).

The measurement program 114 may include various software elements for measuring an SOC of a battery which corresponds to a power supply means of the electronic device 100.

The measurement program 114 may measure an amount of consumption current of the battery when the electronic device enters a low-power mode. The measurement program 114 may measure the amount of consumption current of the battery using the measured SOC of the battery.

Since the SOC of the battery may be measured based on a voltage of the battery, the measurement program 114 may measure the amount of consumption current of the battery based on the voltage of the battery. In another example, the measurement program 114 may measure the amount of consumption current of the battery based on an amount of electric charge inputted to or outputted from the battery.

The determination program 115 may include various software elements for determining a time to clean at least one process.

The determination program 115 may determine a process cleaning time to stop at least one process which consumes the battery based on the amount of battery consumption current measured in the low-power mode. For example, when an amount of battery consumption current greater than or equal to a predefined threshold value is measured in the low-power mode, the determination program 115 determine that it is time to clean at least one process which consumes the battery.

The cleaning program 116 may include various software programs for stopping at least one process which is being operated in the low-power mode at the time which is determined to be time to clean the process.

The cleaning program 116 may process not to consume the current of the battery by the predefined threshold value or more in the low-power mode.

For example, the cleaning program 116 may stop at least one application or function of the electronic device 100 which occupies a processor or a memory at the time which is determined to be time to clean the process. The cleaning program 116 may stop all of the processes which are being operated at the time which is determined to be time to clean the process, or may stop only the operation of a process which is defined by a level of the amount of battery consumption current.

The cleaning program 116 may automatically stop the operation of the process or stop the operation of all or a part of the processes according to user selection at the time which is determined to be time to clean the process.

The cleaning program 116 may output the operation of stopping the operation of the at least one process to at least one display device functionally connected with the electronic device. According to an exemplary embodiment, the display device may be a cover which is installed in the electronic device and is provided with a display protection function.

According to various exemplary embodiments, the cleaning program 116 may output the operation of stopping the operation of the at least one process through at least one other electronic device communicably connected with the electronic device.

The output program 117 may include various software elements for providing and displaying graphics on the touch screen 160. The term “graphics” may be used as a meaning including a text, a web page, an icon, a digital image, a video, an animation, etc.

The output program 117 may include various software elements related to a user interface.

The output program 117 may output the operation of stopping the operation of at least one process which is being operated at the time which is determined to be time to clean the process as described above.

The output program 117 may classify the amount of battery consumption current into a plurality of levels, and output an operation of defining a process to be cleaned according to the classified levels.

When an amount of consumption current greater than or equal to a threshold value is measured in the low-power mode, the output program 117 may output a menu to determine whether to perform the operation of cleaning the process.

The application program 118 may include a software element regarding at least one application program installed in the electronic device 100, and a program for measuring an amount of consumption current of the battery and stopping a process which consumes the battery according to the amount of consumption current may be included in the application program 118. This means that a function of stopping an operation of a process which consumes the battery in the low-power mode may be provided as a single application.

The application program 118 may include an application to stop an operation of an unnecessary process, for example, an operation of a process which occupies a memory or a processor. For example, when the amount of battery consumption current is greater than or equal to the threshold value in the low-power mode, the electronic device 100 may execute an application which is one of the application programs, and stop the operation of the process which consumes the battery.

In addition, the above-mentioned program may be a hardware configuration and this module may be expressed as a set of controllers.

The processor unit 120 may include at least one processor 122 or interface 124. Herein, the processor 122 or interface 124 may be integrated into at least one integrated circuit or may be implemented as a separate element.

The interface 124 may serve as a memory interface to control access to the processor 122 and the memory 110.

The interface 124 may serve as a peripheral device interface to control connection between an input and output peripheral device of the electronic device 100 and the processor 122.

The processor 122 may control the electronic device 100 not to consume the battery by a process which occupies the memory or processor in the low-power mode using at least one software program. The processor 122 may control to measure the amount of battery consumption current in the low-power mode using the SOC of the battery.

The processor 122 may measure the amount of battery consumption current in the low-power mode using a voltage of the battery, an amount of electric charge inputted to and outputted from the battery, etc. in addition to the SOC of the battery.

The processor 122 may execute at least one program stored in the memory 110 and control to perform a function corresponding to the corresponding program. The processor 122 may include a power management processor to manage power of the electronic device 100. The power management processor may determine it is necessary to clean a process based on the amount of consumption current of the battery in the low-power mode, and, when it is necessary to clean the process, may process to stop the operation of at least one process. For example, when the amount of battery consumption current in the low-power mode is greater than or equal to the predefined threshold value, the power management processor may stop the operation of the process which occupies the memory or the processor.

The function of the electronic device 100 for preventing power consumption may be performed using software such as a program stored in the memory 110 or hardware such as the processor.

The audio processor 130 may provide an audio interface between the user and the electronic device 100 through a speaker 131 or a microphone 132.

The communication system 140 may perform a communication function for voice communication or data communication of the electronic device 100. In this case, the communication system 140 may be divided into a plurality of communication sub modules to support different communication networks. For example, the communication networks may include, but not limited to, a Global System for Mobile Communication (GSM) network, an Enhanced Data GSM Environment (EDGE) network, a Code Division Multiple Access (CDMA) network, a W-Code Division Multiple Access (W-CDMA) network, a Long Term Evolution (LTE) network, an Orthogonal Frequency Division Multiple (OFDMA) network, a wireless LAN, a Bluetooth network, Near Field Communication (NFC), etc.

The input and output controller 150 may provide an interface between an input and output device such as the touch screen 160 or the input device 170, and an interface.

The touch screen 160 is an input and output device which outputs or inputs information, and may include a touch input unit 161 and a display unit 162.

The touch input unit 161 may provide touch information which is detected through a touch panel to the processor unit 120 through the input and output controller 150. In this case, the touch input unit 161 may change the touch information to controller configuration such as touch_down, touch_move, or touch_up, and provide the touch information to the processor unit 120, and may generate input data for defining a process to be cleaned according to a level of the amount of battery consumption current in the low-power mode. The touch input unit 161 may generate input data for stopping at least one process which occupies the memory or the processor in the low-power mode.

The display unit 162 may display state information of the electronic device 100, a text inputted by the user, a moving picture, a still picture, etc. For example, the display unit 162 may output the operation of reducing battery consumption by stopping the operation of at least one process which occupies the memory or processor, and output the operation of classifying the amount of battery consumption current into a plurality of levels and defining a process to be cleaned according to the classified levels. When the battery is consumed by the operation of a process occupying the memory or the processor in the low-power mode, the display unit 162 may output a menu to execute the operation of cleaning the process.

The input device 170 may provide input data which is generated by user's selection to the processor unit 120 through the input and output controller 150. For example, the input device 170 may include only a control button to control the electronic device 100. In another example, the input device 170 may include a keypad to receive input data from the user, and may generate input data for defining a process to be cleaned according to a level of the amount of battery consumption current in the low-power mode. The input device 170 may generate input data for stopping the operation of at least one process which occupies the memory or the processor in the low-power mode.

Although not shown in the drawings, the electronic device 100 may further include elements for providing additional functions, such as a broadcast receiving module to receive a broadcast, a digital sound reproducing module such as an MP3 module, a short-distance wireless communication module for short-distance wireless communication, an image sensor to acquire image data, or a proximity sensor module to sense proximity, and software for the operations thereof.

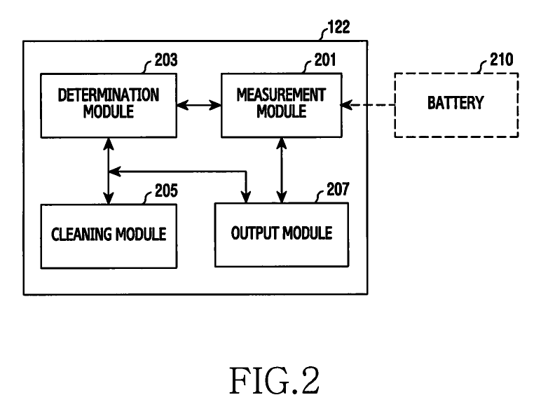

FIG. 2 illustrates a detailed block diagram of the processor for reducing battery consumption in the low-power mode according to an exemplary embodiment of the present disclosure.

Referring to FIG. 2, the processor 122 may include a measurement module 201, a determination module 203, a cleaning module 205, and an output module 207.

The measurement module 201 may measure an SOC of a battery 210 mounted in the electronic device 100, a voltage of the battery, an amount of electric charge inputted to or outputted from the battery, etc.

The measurement module 201 may measure an amount of consumption current of the battery 210 based on the SOC of the battery 210, the voltage of the battery, or the amount of electric charge inputted to or outputted from the battery.

The measurement module 201 may measure the amount of consumption current of the battery 210 when the electronic device 100 enters the low-power mode, and may periodically measure the amount of consumption current of the battery 210 at predefined times.

The measurement module 201 may measure the amount of consumption current of the battery 210 at the time when the SOC of the battery 210 is changed.

The determination module 203 may determine a time to clean at least one process which consumes the battery based on the amount of consumption current of the battery 210.

The determination module 203 may measure the amount of battery consumption current in the low-power mode, and determine a time at which the battery is consumed by a threshold value or more.

The cleaning module 205 may stop at least one process which is being operated in the low-power mode at the time which is determined to be time to clean the process in the low-power mode.

The cleaning module 205 may stop at least one process which occupies the processor or the memory at the time which is determined to be time to clean the process in the low-power mode.

The cleaning module 205 may stop all of the processes which are being operated at the time which is determined to be time to clean the process in the low-power mode, or stop only the operation of a process which is defined by a level of the amount of battery consumption current.

The cleaning module 205 may automatically stop at least one process which occupies the processor or the memory at the time which is determined to be time to clean the process in the low-power mode, or may stop the process according to user's selection.

The output module 207 may output the operation of stopping the operation of at least one process which is being operated at the time which is determined to be time to clean the process. For example, the output module 207 may output an operation of defining a process to be cleaned at the process cleaning time, an operation of informing of time of the process cleaning operation, an operation of informing of execution of the process cleaning operation, or a result of cleaning a process, etc.

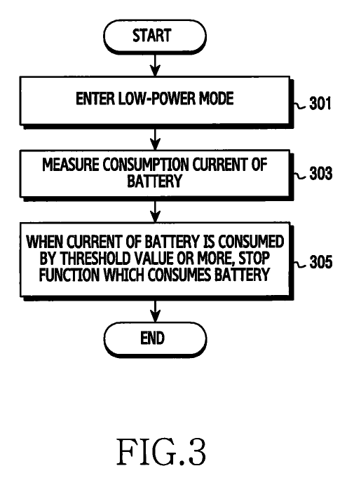

FIG. 3 is a flowchart illustrating an operation of reducing battery consumption in an electronic device according to an exemplary embodiment of the present disclosure.

Referring to FIG. 3, the electronic device may use a battery of a limited capacity as a power supplying means, and may perform an operation of reducing battery consumption in order to support various functions with the battery of the limited capacity.

The electronic device may enter a low-power mode to reduce the battery consumption as in operation 301. The electronic device may enter the low-power mode when a user's input is not detected during a predetermined time.

After entering the low-power mode, the electronic device may measure an amount of consumption current of the battery as in operation 303. In this case, the electronic device may measure the amount of consumption current of the battery in order to determine whether unnecessary battery consumption occurs or not in the low-power mode. This is because the low-power mode can reduce the battery consumption, but some functions or applications of the electronic device may occupy a memory or a processor even in the low-power mode and thus unnecessary battery consumption may occur.

The electronic device may measure the amount of consumption current of the battery according to various exemplary embodiments of the present disclosure.

According to an exemplary embodiment of the present disclosure, the electronic device may identify the amount of battery consumption current using a change in the SOC of the battery during a predetermined time.

According to another exemplary embodiment of the present disclosure, the electronic device may identify the amount of consumption current of the battery based on a change in the voltage of the battery. In general, since the SOC of the battery is measured based on the voltage of the battery, the consumption current of the battery may be measured based on the change in the voltage of the battery.

According to another exemplary embodiment of the present disclosure, the electronic device may identify the amount of consumption current of the battery based on an amount of electric charge of the battery. In general, since the electronic device can measure the amount of electric charge inputted to or outputted from the battery, the electronic device may measure the amount of consumption current of the battery based on the amount of electric charge inputted to or outputted from the battery.

The electronic device may measure battery consumption using Equation 1 presented below. Equation 1 may be used to measure the amount of battery consumption current using the SOC of the battery.

$$x = \frac{B ( sn - sn - 1 )}{( tn - tn - 1 ) * 100} * 1000 \qquad Equation 1$$

Herein, x denotes the consumption current of the battery [A], and B denotes the total capacity of the battery [Ah]. Furthermore, s denotes the SOC of the battery [%] and t denotes time [h].

Referring to Equation 1, it can be seen that the amount of consumption current of the battery is measured using a change in the SOC of the battery between time to and time tn−1.

When a consumption current greater than or equal to a threshold value is consumed while the electronic device enters the low-power mode, the electronic device may process to stop a function which consumes the battery as in operation 305.

For example, when the current of the battery is abnormally consumed in the low-power mode, the electronic device may stop an operation of an unnecessary process or application occupying the processor or the memory.

In this case, the electronic device may automatically stop the operation of the unnecessary process or application at the time at which it is determined that the current of the battery is abnormally consumed, or may stop the operation of the unnecessary process or application according to user's selection.

Furthermore, when it is determined that the current of the battery is abnormally consumed, the electronic device may stop only an operation of a function or application which consumes the battery by the threshold value or more.

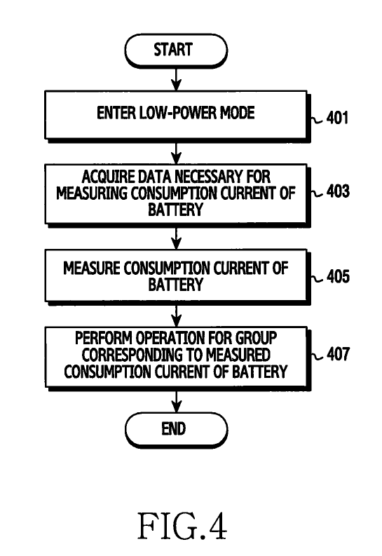

FIG. 4 is a flowchart illustrating an operation of reducing battery consumption in an electronic device according to an exemplary embodiment of the present disclosure.

Referring to FIG. 4, the electronic device may use a battery of a limited capacity as a power supplying means, and may perform an operation of reducing battery consumption in order to support various functions with the battery of the limited capacity.

The electronic device may classify an amount of battery consumption current into at least one level, and define a type of a function or an application for stopping its operation according to the classified level.

This is because some of the elements (functions or applications of the electronic device) consuming the battery may need to maintain its operation.

The element which needs to maintain its operation may be defined by the user or may be defined based on user's preference, frequency of use, etc.

The element which needs to maintain its operation may be defined based on the amount of battery consumption current from among the functions of the electronic device.

The electronic device described above may enter a low-power mode to reduce battery consumption as in operation 401. The electronic device may enter the low-power mode when a user's input is not detected during a predetermined time.

After entering the low-power mode, the electronic device may acquire data necessary for measuring the consumption current of the battery as in operation 403. Herein, the electronic device may measure the amount of battery consumption current to determine an unnecessary function or an operation of application in the low-power mode.

The electronic device may measure an SOC of the battery using a fuel gauge.

The electronic device may use the SOC of the battery measured during a predetermined time to measure the battery consumption current.

The fuel gauge may measure the SOC of the battery based on a voltage of the battery.

The electronic device may use a change in the battery voltage during a predetermined time in measuring the battery consumption current.

The electronic device may measure the amount of consumption current of the battery using various data in addition to the SOC of the battery and the voltage of the battery mentioned above. For example, since the electronic device may measure an amount of electric charge inputted to or outputted from the battery, the electronic device may use the amount of electric charge inputted to or outputted from the battery in measuring the consumption current of the battery.

To measure the amount of consumption current of the battery, the electronic device may acquire data such as the SOC of the battery measured by the fuel gauge, the voltage of the battery, and the amount of electric charge inputted to or outputted from the battery.

The electronic device may measure the amount of consumption current of the battery using the data which is used for measuring the consumption current of the battery as in operation 405.

For example, the electronic device may measure the amount of battery consumption current during a predetermined time using the SOC of the battery during a predetermined time.

When the SOC of the battery during the predetermined time is changed by a predefined threshold value or more, the electronic device may determine that a large amount of current is consumed in the battery.

In this case, the electronic device may measure the battery consumption using Equation 2:

$$x = \frac{B ( sn - sn - 1 )}{( tn - tn - 1 ) * 100} * 1000 \qquad Equation 2$$

Herein, x denotes the consumption current of the battery [A], and B denotes the total capacity of the battery [Ah]. Furthermore, s denotes the SOC of the battery [%] and t denotes time [h].

Referring to Equation 2, it can be seen that the amount of consumption current of the battery is measured using a change in the SOC of the battery between time to and time tn−1.

The fuel gauge may measure the SOC of the battery based on the voltage of the battery.

The electronic device may measure the amount of battery consumption current during a predetermined time using a change in the battery voltage during a predetermined time.

When the battery voltage is changed by a predefined threshold value or more during a predetermined time, the electronic device may determine that a large amount of current is consumed in the battery.

The electronic device may measure the amount of battery consumption current using the amount of electric charge inputted to or outputted from the battery, etc. in addition to the SOC of the battery and the voltage of the battery mentioned above.

The electronic device may identify a type of a function or application corresponding to a level of the measured battery consumption current and may stop the operation thereof as in operation 407.

For example, it may be assumed that the electronic device defines the amount of battery consumption current as having first to third levels.

The first level may indicate that the battery consumption current is in a range less than or equal to a threshold value, and the third level may indicate that the battery consumption current is in a range greater than or equal to a threshold value. A medium range between the first level and the third level may be defined as the second level.

When the amount of consumption current of the battery corresponding to the third level is measured, the electronic device may stop the operations of unnecessary function and application.

Furthermore, when the amount of consumption current of the battery corresponding to the first level is measured, the electronic device may stop only the operation of some functions and applications which consume a great amount of current of the battery.

In this case, the electronic device may automatically stop the operation of the unnecessary process or application or may stop the operation of the unnecessary process or application according to user's selection at the time when it is determined that the current of the battery is abnormally consumed.

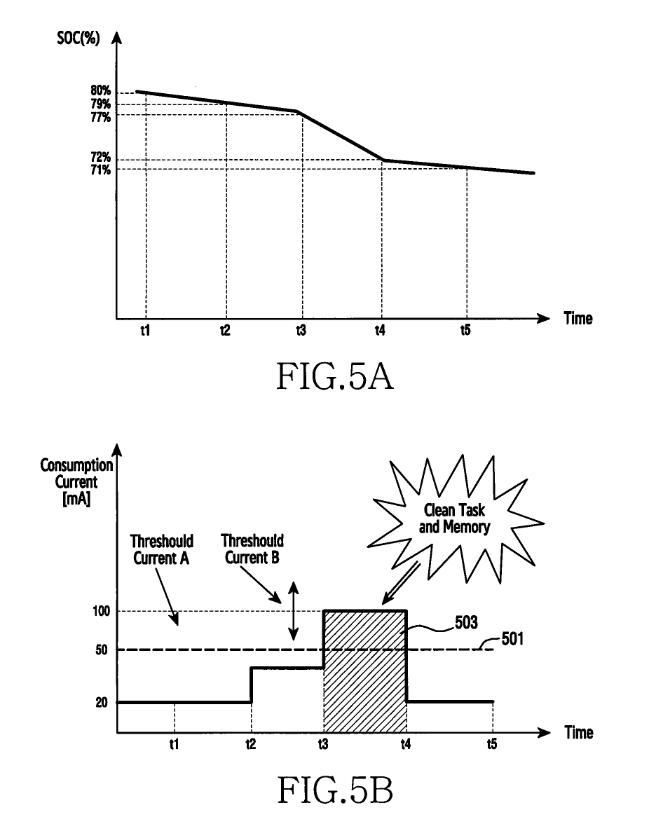

FIG. 5 is a view showing a situation in which an amount of consumption current of a battery is periodically measured at predetermined times in an electronic device according to an exemplary embodiment of the present disclosure.

View (a) of FIG. 5 illustrates a graph showing an SOC of the battery which is periodically measured at predetermined times in the electronic device.

Referring to view (a) of FIG. 5, the electronic device may measure the SOC of the battery at an interval of time t. Of course, the electronic device may measure the SOC of the battery using a fuel gauge connected with the battery.

The illustrated graph indicates that an SOC of the battery corresponding to 80% was measured at time t1, and an SOC of the battery corresponding to 79% was measured at time t2. It can be seen from the graph that the SOC of the battery was changed by 1% between time t1 and time t2.

Furthermore, it can be seen that the SOC of the battery changes from 77% to 72% between time t3 and time t4.

View (b) of FIG. 5 illustrates a graph showing measurement of the amount of battery consumption current based on the amount of consumption current of the battery in the electronic device.

Referring to view (b) of FIG. 5, the electronic device may measure the amount of consumption current of the battery using the SOC of the battery, the voltage of the battery, the amount of electric charge inputted to or outputted from the battery, etc. However, in the following description, an example of measuring the amount of consumption current of the battery using the SOC of the battery will be explained.

The electronic device may use Equation 3 presented below in measuring the amount of battery consumption current as described above:

$$x = \frac{B ( sn - sn - 1 )}{( tn - tn - 1 ) * 100} * 1000 \qquad Equation 3$$

Herein, x denotes the consumption current of the battery [A], and B denotes the total capacity of the battery [Ah]. Furthermore, s denotes the SOC of the battery [%] and t denotes time [h].

Referring to Equation 3, it can be seen that the amount of consumption current of the battery is measured using a change in the SOC of the battery between time to and time tn−1.

The electronic device may define a reference value (threshold value) 501 for the consumption current of the battery to clean an unnecessary process.

When a battery consumption current greater than or equal to the predefined reference value is measured (503), the electronic device may process to stop the operation of the unnecessary process or to clean the memory (505).

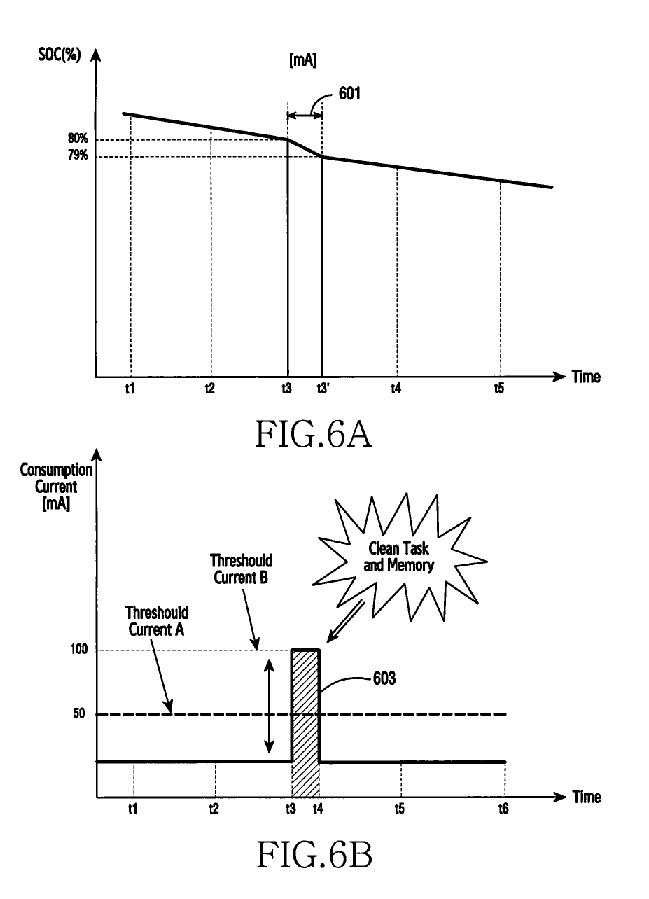

When the electronic device measures the amount of battery consumption current using the SOC of the battery measured every predetermined times, the electronic device may exactly determine the time to clean the unnecessary process. However, since the amount of battery consumption current is periodically measured, the time during which a large amount of current is consumed in the electronic device by the unnecessary process increases and thus the battery of the electronic device may be consumed. Accordingly, the electronic device may perform an operation shown in FIG. 6 to solve this problem.

FIG. 6 is a view showing a situation in which an amount of consumption current of the battery is measured in the electronic device at the time when the SOC of the battery is changed according to an exemplary embodiment of the present disclosure.

View (a) of FIG. 6 illustrates a graph showing the SOC of the battery which is periodically measured at predefined times.

Referring to view (a) of FIG. 6, the electronic device may measure the SOC of the battery at an interval of time t. Of course, the electronic device may measure the SOC of the battery using a fuel gauge connected with the battery.

The illustrated graph indicates that the SOC of the battery corresponding to 80% was measured until time t3, and the SOC of the battery corresponding to 79% was measured between time t3 and time t3′ (601).

The electronic device may measure the amount of battery consumption current at the time when the SOC of the battery is changed as described above.

View (b) of FIG. 6 illustrates a graph showing measurement of the amount of battery consumption current based on the amount of consumption current of the battery in the electronic device.

Referring to view (b) of FIG. 6, the electronic device may measure the amount of consumption current of the battery using the SOC of the battery, the voltage, the amount of electric charge inputted to or outputted from the battery, etc. However, in the following description, an example of measuring the amount of consumption current of the battery using the SOC of the battery will be explained.

The electronic device may use Equation 4 presented below in measuring the amount of battery consumption current as described above:

$$x = \frac{B ( sn - sn - 1 )}{( tn - tn - 1 ) * 100} * 1000 \qquad Equation 4$$

Herein, x denotes the consumption current of the battery [A], and B denotes the total capacity of the battery [Ah]. Furthermore, s denotes the SOC of the battery [%] and t denotes time [h].

Referring to Equation 4, it can be seen that the amount of consumption current of the battery is measured using a change in the SOC of the battery between time to and time tn−1.

The electronic device may define a reference value (threshold value) for the consumption current of the battery to clean an unnecessary process.

When a battery consumption current greater than or equal to the predefined reference value is measured (603), the electronic device may process to stop the operation of the unnecessary process or to clean the memory.

The electronic device may measure the amount of battery consumption current using the SOC of the battery which is measured every predetermined times as shown in FIG. 5, but may measure the amount of battery consumption current at the time when the SOC of the battery is changed as shown in FIG. 6.

This means that the period for determining the amount of battery consumption current can be adjusted. For example, when the period for determining the amount of battery consumption current is short, the unnecessary process can be detected rapidly.

In the illustrated drawings, sections displayed by the dashed lines indicate sections in which the amount of battery consumption current is periodically determined, and a section displayed by the solid line indicates a section in which the amount of battery consumption current is determined at the time when the SOC of the battery is changed.

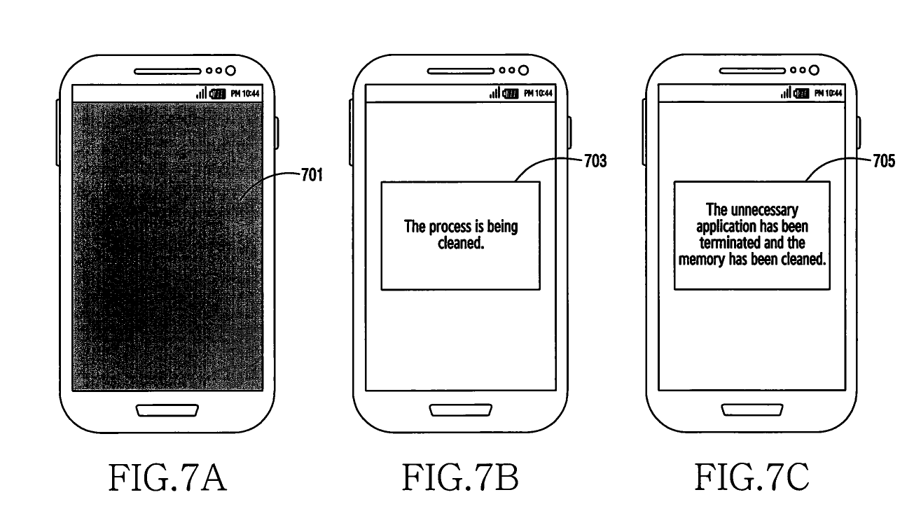

FIG. 7 is a view showing an operation of an electronic device for reducing power consumption in a low-power mode according to an exemplary embodiment of the present disclosure.

Referring to FIG. 7, the electronic device may use a battery of a limited capacity as a power supplying means, and may perform an operation of reducing consumption of the battery to support various functions with the battery of the limited capacity.

The electronic device may enter a low-power mode when a user's input is not detected during a predetermined time as shown in view (a) of FIG. 7.

In the illustrated drawing, the electronic device which determines that the user does not use the electronic device may enter the low-power mode by stopping the operation of a display unit (for example, LCD off), and a shading-processed screen 701 may mean a situation in which the operation of the display unit is stopped.

The electronic device entering the low-power mode as described above may measure an amount of consumption current of the battery.

In this case, the electronic device may measure the amount of consumption current of the battery using SOC information of the battery. For example, when it is determined that the SOC of the battery is changed by a predefined threshold value or more, the electronic device may determine that a large amount of current of the battery is consumed. The electronic device may measure the amount of consumption current of the battery using a voltage of the battery, an amount of electric charge inputted to or outputted from the battery, etc. in addition to the SOC information of the battery.

The electronic device may measure the amount of consumption current of the battery every predetermined times.

The electronic device may measure the amount of consumption current of the battery every time the SOC of the battery is changed.

When the electronic device determines that a large amount of current of the battery is consumed, the electronic device may perform an operation 703 of cleaning an unnecessary process as shown in view (b) of FIG. 7. In this case, the electronic device may stop an operation of a function which occupies a processor and a memory in the low-power mode.

The electronic device which has finished the operation of cleaning the unnecessary process as described above may output a result of stopping the operation of the function which may consume the current in the low-power mode as shown in view (c) of FIG. 7 (705).

In the above description, the electronic device cleans the unnecessary process after disabling the low-power mode. However, the electronic device may perform the operation of cleaning the unnecessary process while maintaining the low-power mode. In this case, the electronic device may not output information indicating the performance of the operation of cleaning the unnecessary process and the result thereof as shown in views (b) and (c) of FIG. 7.

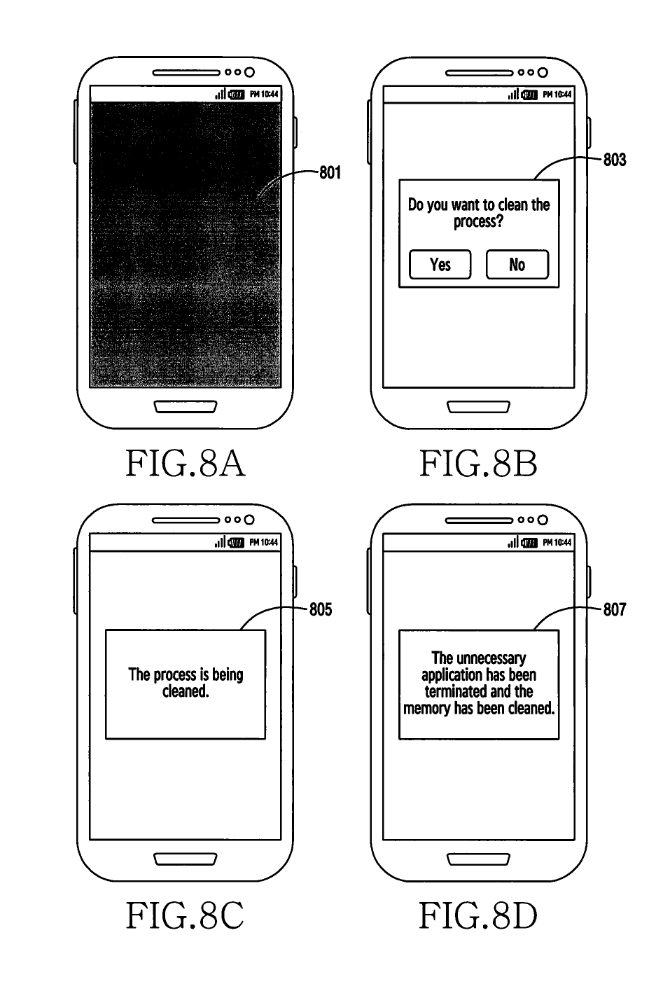

FIG. 8 is a view showing another operation of the electronic device for reducing the power consumption in the low-power mode according to an exemplary embodiment of the present disclosure.

Referring to FIG. 8, the electronic device may use a battery of a limited capacity as a power supplying means, and may perform an operation of reducing consumption of the battery to support various functions with the battery of the limited capacity.

The electronic device may enter the low-power mode when a user's input is not detected during a predetermined time as shown in view (a) of FIG. 8.

In the illustrated drawings, the electronic device which determines that the user does not use the electronic device may enter the low-power mode by stopping the operation of a display unit (for example, LCD off), and a shading-processed screen 801 may mean a situation in which the operation of the display unit is stopped.

The electronic device entering the low-power mode as described above may measure an amount of consumption current of the battery.

In this case, the electronic device may measure the amount of consumption current of the battery using SOC information of the battery. For example, when it is determined that the SOC of the battery is changed by a predefined threshold value or more, the electronic device may determine that a large amount of current of the battery is consumed. The electronic device may measure the amount of consumption current of the battery using a voltage of the battery, an amount of electric charge inputted to or outputted from the battery, etc. in addition to the SOC information of the battery.

The electronic device may measure the amount of consumption current of the battery every predetermined times.

The electronic device may measure the amount of consumption current of the battery every time the SOC of the battery is changed.

When the electronic device determines that a large amount of current of the battery is consumed, the electronic device may output a menu 803 to select whether to perform an operation of cleaning an unnecessary process as shown in view (b) of FIG. 8. 25 Of course, the electronic device may automatically perform the operation of cleaning the unnecessary process at the time when the consumption current of the battery is greater than or equal to a threshold value as shown in FIG. 7.

When it is determined that the operation of cleaning the unnecessary process is not necessary, the electronic device may keep entering the low-power mode.

When it is determined that the operation of cleaning the unnecessary process is necessary, the electronic device may perform the operation of cleaning the unnecessary process as shown in view (c) of FIG. 8 (805).

In this case, the electronic device may stop an operation of a function which occupies a processor and a memory in the low-power mode.

The electronic device may detect a user's input and determine whether to perform the operation of cleaning the unnecessary process.

After disabling the low-power mode, the electronic device may perform the operation of cleaning the unnecessary process.

The electronic device which has finished the operation of cleaning the unnecessary process as described above may output a result of stopping the operation of the function which may consume the power in the low-power mode as shown in view (d) of FIG. 8 (807).

The electronic device may clean the unnecessary process with the low-power mode being disabled or with only some functions being activated, as well as with the low-power mode being disabled as described above.

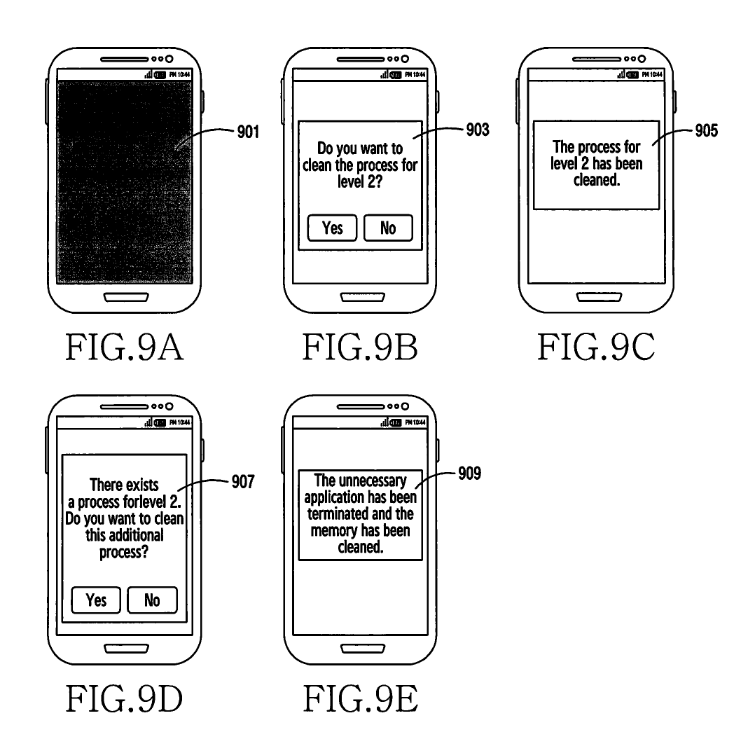

FIG. 9 is a view showing another operation of the electronic device for reducing the power consumption in the low-power mode according to an exemplary embodiment of the present disclosure.

Referring to FIG. 9, the electronic device may use a battery of a limited capacity as a power supplying means, and may perform an operation of reducing consumption of the battery to support various functions with the battery of the limited capacity.

The electronic device may classify an amount of battery consumption current into at least one level, and define a type of a function or application for stopping its operation according to the classified level.

This is because some of the elements (functions or applications of the electronic device) consuming the battery may need to maintain its operation.

The element which needs to maintain its operation may be defined by the user or may be defined based on user's preference, frequency of use, etc.

The element which needs to maintain its operation may be defined based on the amount of battery consumption current from among the functions of the electronic device.

The electronic device may enter the low-power mode when a user's input is not detected during a predetermined time as shown in view (a) of FIG. 9.

In the illustrated drawing, the electronic device which determines that the user does not use the electronic device may enter the low-power mode by stopping the operation of a display unit (for example, LCD off), and a shading-processed screen 901 may mean a situation in which the operation of the display unit is stopped.

The electronic device entering the low-power mode as described above may measure an amount of consumption current of the battery.

In this case, the electronic device may measure the amount of consumption current of the battery using SOC information of the battery. For example, when it is determined that the SOC of the battery is changed by a predefined threshold value or more, the electronic device may determine that a large amount of current of the battery is consumed. The electronic device may measure the amount of consumption current of the battery using a voltage of the battery, an amount of electric charge inputted to or outputted from the battery, etc. in addition to the SOC information of the battery.

The electronic device may measure the amount of consumption current of the battery every predetermined times.

The electronic device may measure the amount of consumption current of the battery every time the SOC of the battery is changed.

The electronic device may determine whether there exists a function that should stop its operation based on the measured amount of battery consumption current.

The electronic device may output a menu 903 to select whether to perform an operation of cleaning an unnecessary process corresponding to the measured amount of battery consumption current as shown in view (b) of FIG. 9. Of course, the electronic device may automatically perform the operation of cleaning the unnecessary process at the time when the consumption current of the battery is greater than or equal to a threshold value as shown in FIG. 7.

In the illustrated drawing, after measuring an amount of battery consumption current corresponding to level 2, the electronic device may output the menu to determine whether to clean a process defined by level 2.

When it is determined that the operation of cleaning the unnecessary process is not necessary, the electronic device may keep entering the low-power mode.

When it is determined that the operation of cleaning the unnecessary process is necessary, the electronic device may perform the operation of cleaning the unnecessary process, and then output a result of stopping the operation of the function which may consume the power in the low-power mode as shown in view (c) of FIG. 9 (905).

In this case, the electronic device may stop only the operation of the function corresponding to the level of the amount of battery consumption current from among the functions which occupy the processor and the memory in the low-power mode, and some functions may continue consuming power.

Accordingly, the electronic device may output a menu 907 to determine whether to perform an operation of cleaning a process of a function which currently consumes power as shown in view (d) of FIG. 9.

In the illustrated drawing, the electronic device may notify the user that a process corresponding to level 1 consumes power, and determine whether to clean such a process or not.

When it is determined that it is not necessary to clean the unnecessary process, the electronic device may clean only the process which corresponds to the amount of battery consumption current and then enter the low-power mode.

When it is determined that it is necessary to additionally clean an unnecessary process, the electronic device may perform the operation of cleaning the unnecessary process according to user's selection, and then output a result of stopping the operation of the function which may additionally consume power as shown in view (e) of FIG. 9 (909).

According to the present disclosure, the electronic device may output process end information to at least one display device functionally connected with the electronic device. According to an exemplary embodiment, the display device may be a cover which is installed in the electronic device and is provided with a display protection function.

According to various exemplary embodiments, the electronic device may output the process end information through at least one other electronic device communicably connected with the electronic device. According to an exemplary embodiment, the electronic device may be set to communicate with at least one other electronic device using a wire or wireless communication method. According to an exemplary embodiment, the wireless communication method may include a short-distance communication method. According to an exemplary embodiment, the short-distance communication method may be at least one of Bluetooth communication, RF communication, infrared communication, WiFi communication, medium communication, NFC communication, and Zigbee communication. According to an exemplary embodiment, the at least one other electronic device may be a wearable electronic device. According to an exemplary embodiment, the wearable electronic device may be a watch-type electronic device. According to an exemplary embodiment, the other electronic device may be wearable on a head portion or an arm of a human body.

While the present invention has been particularly shown and described with reference to exemplary embodiments thereof, it will be understood by those skilled in the art that various changes in form and details may be made therein without departing from the spirit and scope of the present invention as defined by the appended claims. Therefore, the scope of the invention is defined not by the detailed description of the exemplary embodiments but by the appended claims, and the equivalents to the scopes of the claims.

1. An electronic device comprising:
a measurement module configured to measure an amount of consumption current of a battery in a low-power mode;
a determination module configured to determine a time to clean at least one process; and
a cleaning module configured to, when it is determined that it is necessary to clean at least one process, terminate at least one process which is being operated in the low-power mode.

2. The electronic device of claim 1, wherein the measurement module is configured to measure the amount of consumption current of the battery based on at least one of an SOC of the battery, a voltage of the battery, and an amount of electric charge inputted to or outputted from the battery.

3. The electronic device of claim 1, wherein the measurement module is configured to measure the amount of consumption current of the battery based on a predetermined time period, or measure the amount of consumption current of the battery based on a change in a measurement value of at least one of an SOC of the battery, a voltage of the battery, and an amount of electric charge inputted to or outputted from the battery.

4. The electronic device of claim 1, wherein the cleaning module is configured to terminate a process which is being operated according to a level corresponding to at least one of the measured battery consumption current, a SOC of the battery, and a voltage of the battery.

5. The electronic device of claim 1, wherein the cleaning module is configured to terminate an operation of at least one process which occupies a memory or a processor.

6. The electronic device of claim 1, further comprising an output module configured to output an operation of cleaning the at least one process.

7. The electronic device of claim 6, wherein the output module is configured to output at least one operation of an operation of selecting a process to be cleaned at the process cleaning time, an operation of informing of the time of the process cleaning operation, an operation of informing of execution of the process cleaning operation, and an operation of informing a result of cleaning a process.

8. A method of an electronic device, comprising:
determining whether a battery is consumed by a predetermined threshold value or more based on an amount of consumption current of the battery in a low-power mode; and
when the battery is consumed by the predetermined threshold value or more, terminating at least one process which is being currently operated.

9. The method of claim 8, wherein the amount of consumption current of the battery is periodically measured at predetermined times, or is measured based on a change in a measurement value of at least one of an SOC of the battery, a voltage of the battery, and an amount of electric charge inputted to or outputted from the battery.

10. The method of claim 8, wherein the terminating the at least one process is performed in a state in which the low-power mode is maintained or a state in which the low-power mode is disabled.

11. The method of claim 8, wherein the terminating the at least one process comprises terminating a process which is being operated based on the consumption current of the battery.

12. The method of claim 8, wherein the terminating the at least one process comprises:
terminating at least one process which consumes the battery; and
additionally terminating an operation of at least one process from among processes which are being operated.

13. The method of claim 8, further comprising:
determining whether the at least one process which is being currently operated satisfies a predefined condition or not; and
ruling at least one process satisfying the condition out of the processes to be terminated, and
wherein the predefined condition comprises at least one of preference for the process, frequency of use, and priority.

14. The method of claim 8, further comprising outputting the operation of terminating the at least one process to at least one display device functionally connected with the electronic device or at least one other electronic device communicably connected with the electronic device.

15. The method of claim 14, wherein the outputting to the display device or the other electronic device comprises at least one of: selecting a process to be cleaned at the process cleaning time; informing of the time of the process cleaning operation, informing of execution of the process cleaning operation, and informing of a result of cleaning a process.
